(19) United States
(12) Patent Application Publication
(10) Pub. No.: US 2009/0138129 A1
(43) Pub. Date: May 28, 2009

(54) Freezer Heat Exchanger Coolant Flow Divider Control Device

(76) Inventor: Takayuki Setoguchi, Osaka (JP)

Correspondence Address: BIRCH STEWART KOLASCH & BIRCH, PO BOX 747, FALLS CHURCH, VA, 22040-0747, US

(21) Appl. No.: 12/224,596

(22) PCT Filed: Mar. 7, 2007
(86) PCT No.: PCT/JP2007/054473

§ 371 Date: Sep. 2, 2008

(30) Foreign Application Priority Data
Mar. 8, 2006 (JP) 2006-062479

(51) Int. Cl. G05D 7/00; F25D 23/00

(52) U.S. Cl. 700/282; 62/259.1

(57) ABSTRACT

A controller of a refrigerant flow divider of a heat exchanger for a refrigerating device is provided. The controller supplies refrigerant to each one of a plurality of paths of the heat exchanger through the refrigerant flow divider having a plurality of paths. An electromagnetic on-off valve is provided in each of the paths of the refrigerant flow divider. The flow rate of the refrigerant in each path is adjusted relatively in correspondence with the difference in the number of times of the opening and closing per unit time among the electromagnetic on-off valves.

### TECHNICAL FIELD

The present invention relates to a refrigerating device of an air conditioner or the like, and, more particularly, a refrigerant flow divider controller that distributes refrigerant appropriately to a plurality of paths of a heat exchanger for a refrigerating device.

### BACKGROUND ART

Typically, in a refrigerating device of an air conditioner or the like, an indoor heat exchanger having a plurality of paths includes a refrigerant flow divider. The refrigerant flow divider has a plurality of dividing paths through which the refrigerant that has flowed into the heat exchanger is distributed to each of the paths of the heat exchanger. The distribution ratio of the refrigerant flowing in the respective dividing paths of the refrigerant flow divider is determined in accordance with a rated operation.

Thus, in the rated operation, the temperatures of the refrigerant in the vicinities of the outlets of the respective paths become substantially equal in the vicinity of the outlet of the heat exchanger. However, in a low load state (a partial load state) where the flow rate of the refrigerant is low, the refrigerant temperatures are influenced by a wind velocity, which varies depending on the position of an air blowing passage of the heat exchanger. Specifically, since any path located at a position where the wind velocity is high has a sufficient heat exchange capacity, the temperature of the refrigerant in the vicinity of the outlet of the path becomes high. In contrast, any path located at a position where the wind velocity is low has an insufficient heat exchange capacity, the temperature of the refrigerant in the vicinity of the outlet of the path becomes lower than the temperature of the refrigerant in the vicinity of the outlet of the path corresponding to the higher wind velocity.

As one solution to this problem, a refrigerant flow control valve may be provided in each path of a heat exchanger. A temperature sensor is arranged in the vicinity of the outlet of each path. The flow rate of the refrigerant flowing in the path is thus adjusted in correspondence with the temperature detected by the temperature sensor. In this manner, the temperatures (the degrees of dryness) of the refrigerant in the vicinities of the outlets of the respective paths are equalized (see, for example, Patent Document 1).

### Patent Document 1: Japanese Laid-Open Patent Publication No. 5-118682

### SUMMARY OF THE INVENTION

However, in this type of conventional refrigerant flow divider, each of the multiple paths must include the refrigerant flow control valve, which is formed by an expensive and large-sized electric expansion valve. This increases the size and the cost of the refrigerant flow divider.

FIG. 9 shows a heat exchanger used in a refrigerating device of an air conditioner or the like. The heat exchanger 1 is capable of carrying out dehumidification in a cooling cycle to improve comfort of cooling. Specifically, in the dehumidification, the humidity of the indoor air is reduced by restricting performance of a compressor or airflow of a fan. The dehumidification includes two types of dehumidification operations, which are a normal “dehumidification operation” and a “reheat dehumidification operation”. In the normal dehumidification operation, the indoor air is cooled and dehumidified and then sent to the interior of the room in a cooled state. In the reheat dehumidification operation, the indoor air is cooled and dehumidified and then reheated to a temperature close to the intake temperature. The air is then provided to the interior of the room. An evaporator heat exchanger 11, which is capable of carrying out these two dehumidification operations, includes a dehumidifying heat exchanger 12 and a reheat dehumidification heat exchanger 13. The dehumidifying heat exchanger 12 is provided at a front side of the evaporator heat exchanger 11, which is a position upstream in the air flow. The reheat dehumidification heat exchanger 13 is arranged at a rear position of the evaporator heat exchanger 1, or a position downstream in the air flow. First to fourth paths P₁ to P₄ are connected to the evaporator heat exchanger 11, the dehumidifying heat exchanger 12, and the reheat dehumidification heat exchanger 13, as illustrated in FIG. 9. Refrigerant is supplied to each of the heat exchangers from a refrigerant supply pipe 4 through the paths P₁ to P₄ of a refrigerant flow divider 3.

In the heat exchanger 1, the flow rate of air in the evaporator heat exchanger 11 varies among an upper portion 11a, a middle portion 11b, and a lower portion 11c. The flow rate of the air in the dehumidifying heat exchanger 12 varies among an upper portion 12a, a middle portion 12b, and a lower portion 12c. Correspondingly, the heat exchange capacity varies from portion to portion in the evaporator heat exchanger 11 and the dehumidifying heat exchanger 12. This disadvantageously varies the temperatures of the refrigerant in the vicinities of the outlets of the paths P₁ to P₄ from one path to another.

In this case, not only refrigerant flow control valves V₁ to V₄ for the paths P₁ to P₄ but also reheat dehumidification valves V₅, V₆ for the reheat dehumidification heat exchanger 13 must be provided. That is, a total of six refrigerant flow control valves (electric expansion valves) are necessary. This increases the size and the cost of the refrigerant flow divider.

If the heat exchanger 1 does not have the function of “reheat dehumidification operation”, as in the case of FIG. 10, at least four refrigerant flow control valves (electric expansion valves) V₁ to V₄ are necessary.

Accordingly, it is an objective of the present invention to provide a refrigerant flow divider controller of a heat exchanger for an air conditioner that employs small-sized and inexpensive a normally on type on-off valve and a normally off type electromagnetic on-off valve and relatively adjusts the flow rates of refrigerant in respective paths in accordance with the difference in the number of times of the opening and closing per unit time between the electromagnetic on-off valves.

To solve the above problem, a first aspect of the present invention provides a controller of a refrigerant flow divider of a heat exchanger for a refrigerating device, which supplies refrigerant to each one of a plurality of paths of the heat exchanger through the refrigerant flow divider having a plurality of paths. An electromagnetic on-off valve is provided in each of the paths of the refrigerant flow divider. The flow rate of the refrigerant in each path is adjusted relatively in correspondence with the difference in the number of times of the opening and closing per unit time among the electromagnetic on-off valves.

This makes it unnecessary to provide a refrigerant flow control valve formed by an electric expansion valve that changes its valve opening degree to highly accurately adjust the flow rate of refrigerant. Thus, compared to the conventional configuration, the size and the cost of the valve portion are prevented from increasing. The electric expansion valve may be used also as a reheat dehumidification valve. Further, if a reheat dehumidification operation is enabled, the reheat dehumidification valve may be configured in the same manner as the above-described structure.

In the controller of the refrigerant flow divider, the flow rate of the refrigerant in each path is adjusted relatively by opening and closing each of the electromagnetic on-off valves by a predetermined duty cycle. This makes it unnecessary to provide a refrigerant flow control valve formed by an electric expansion valve that changes its valve opening degree to highly accurately adjust the flow rate of refrigerant. Thus, compared to the conventional configuration, the size and the cost of the valve portion are prevented from increasing. The electromagnetic on-off valve may be used also as a reheat dehumidification valve. The reheat dehumidification valve may be configured in the same manner as the above-described structure.

In the controller of the refrigerant flow divider, the flow rate of the refrigerant in each path is adjusted relatively by causing self-excited vibration of each of the electromagnetic on-off valves at a predetermined cycle. This makes it unnecessary to provide a refrigerant flow control valve formed by an electric expansion valve that changes its valve opening degree to highly accurately adjust the flow rate of refrigerant. Thus, compared to the conventional configuration, the size and the cost of the valve portion are prevented from increasing. The electromagnetic on-off valve may be used also as a reheat dehumidification valve. The reheat dehumidification valve may be configured in the same manner as the above-described structure.

In the controller of the refrigerant flow divider, each electromagnetic on-off valve is a direct operated electromagnetic valve. This makes it unnecessary to provide a refrigerant flow control valve formed by an electric expansion valve that changes its valve opening degree to highly accurately adjust the flow rate of refrigerant. Thus, compared to the conventional configuration, the size and the cost of the valve portion are prevented from increasing. The electromagnetic on-off valve may be used as a reheat dehumidification valve. The reheat dehumidification valve may be configured in the same manner as the above-described structure.

In the controller of the refrigerant flow divider, the electromagnetic on-off valves are formed by a rotary type electromagnetic valve. This makes it unnecessary, unlike the conventional case, to provide a refrigerant flow control valve formed by an electric expansion valve that varies valve opening degree to highly accurately adjusts the flow rate of. Thus, the size and the cost of the valve portion are prevented from increasing. The electromagnetic on-off valve may be used also as a reheat dehumidification valve. The reheat dehumidification valve may be configured in the same manner as the above-described structure.

In the controller of the refrigerant flow divider, the electromagnetic on-off valves are formed by a sliding type electromagnetic valve. This makes it unnecessary, unlike the conventional case, to provide a refrigerant flow control valve formed by an electric expansion valve that varies a variable valve opening degree to highly accurately adjust the flow rate of refrigerant. Thus, the size and the cost of the valve portion are prevented from increasing. The electromagnetic on-off valve may be used also as a reheat dehumidification valve. The reheat dehumidification valve may be configured in the same manner as the above-described structure.

According to the present invention, instead of using an electromagnetic flow control valve formed by an expensive and high-accuracy electric expansion valve, an inexpensive and simply configured direct operated electromagnetic valve is used as a refrigerant flow control valve. This reduces the size and the cost of the refrigerant flow divider. As a result, if used in an air conditioner having a reheat dehumidification heat exchanger, the refrigerant flow divider is optimal as a refrigerant flow divider that appropriately distributes refrigerant to a plurality of paths of a heat exchanger for a refrigerating device.

### BRIEF DESCRIPTION OF THE DRAWINGS

FIGS. 1(a) and 1(b) are diagrams showing a refrigerant flow divider controller according to a first embodiment of the present invention;

FIG. 2 is a timing chart representing control signals of the refrigerant flow divider controller;

FIGS. 3(a) and 3(b) are diagrams showing a refrigerant flow divider controller according to a second embodiment of the invention;

FIG. 4 is a timing chart representing control signals of the refrigerant flow divider controller;

FIG. 5 is a diagram showing a refrigerant flow divider controller according to a third embodiment of the invention;

FIGS. 6(a) and 6(b) are diagrams showing a main portion of the refrigerant flow divider controller;

FIG. 7 is a timing chart representing control signals of the refrigerant flow divider controller;

FIG. 8 is a diagram showing a refrigerant flow divider controller according to a fourth embodiment of the invention;

FIG. 9 is a diagram showing a refrigerant flow divider controller of a heat exchanger for a refrigerating device that has a function of reheat dehumidification operation; and

FIG. 10 is a diagram showing a refrigerant flow divider controller of a heat exchanger for a refrigerating device without a function of reheat dehumidification operation.

### BEST MODE FOR CARRYING OUT THE INVENTION

### First Embodiment

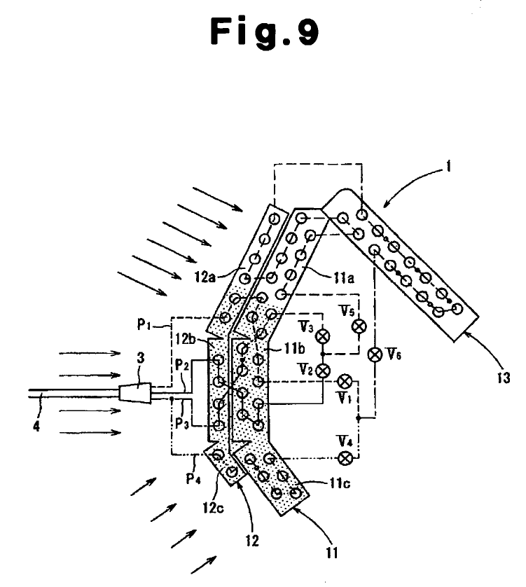

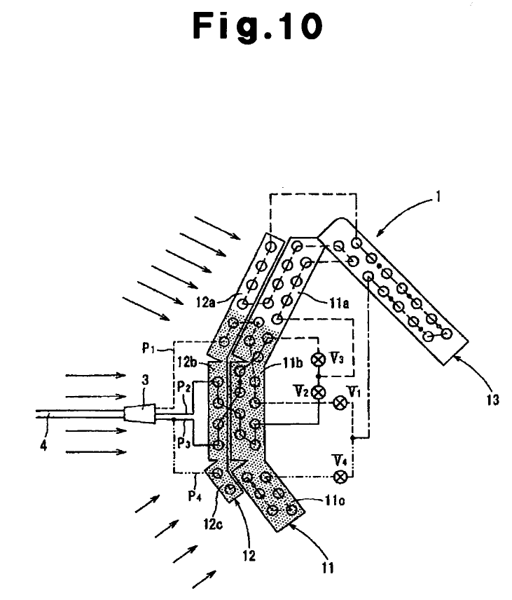

Refrigerant flow control valves V₁ to V₄ of a first embodiment are used to adjust the flow rates of the refrigerants flowing in the paths P₁ to P₄ of the refrigerant flow divider 3 of the conventional air-conditioner heat exchanger 1, which is shown in FIGS. 9 and 10.

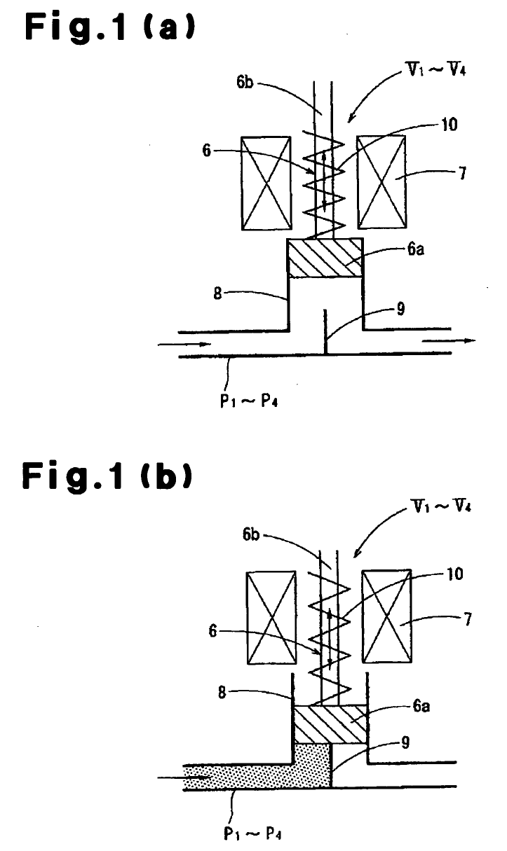

As shown in FIGS. 1(a) and 1(b), each of the refrigerant flow control valves V₁ to V₄ has an electromagnetic plunger 6 including a plunger head (a valve body) 6a and a plunger rod 6b, a solenoid coil 7 operating to raise the plunger rod 6b, and a valve closing spring 10 urging the plunger rod 6b downward. Each refrigerant flow control valve V₁ to V₄ is formed by an on-off type direct operated electromagnetic valve. The plunger head 6a faces a valve seat wall 9, which is located in a sleeve-like pilot recess 8 in each path P₁ to P₄.

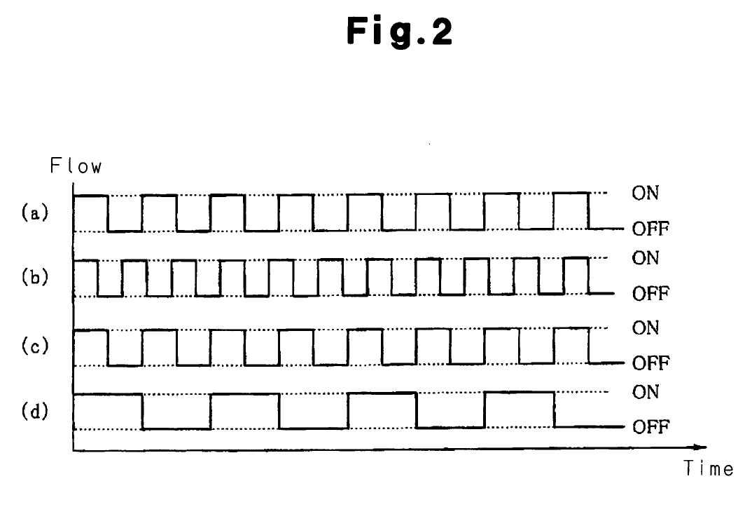

In the first embodiment, in correspondence with control signals of different duty cycles illustrated in FIGS. 2(a) to 2(d), each direct operated electromagnetic valve is switched between an ON state (an energized state shown in FIG. 1(a)) and an OFF state (a nonenergized state shown in FIG. 1(b)). Through such selective opening and closing of the direct operated electromagnetic valve, the flow rate of the refrigerant in each path per unit time is adjusted appropriately in correspondence with the load state (the unevenness) of the path P₁ to P₄.

In this manner, instead of using an electromagnetic flow control valve formed by an expensive and high-accuracy electric expansion valve, an inexpensive and simply configured direct operated electromagnetic valve is used as a refrigerant flow control valve. This reduces the size and the cost of the refrigerant flow divider. As a result, if used in an air conditioner having a reheat dehumidification heat exchanger, the refrigerant flow divider is optimal as a refrigerant flow divider that appropriately distributes refrigerant to a plurality of paths of a heat exchanger for a refrigerating device.

### Second Embodiment

Also in a second embodiment, the refrigerant flow control valves V₁ to V₄ are used to adjust the flows of the refrigerants flowing in the paths P₁ to P₄ of the refrigerant flow divider 3 of the conventional air-conditioner heat exchanger 1, which is shown in FIG. 9 or 10.

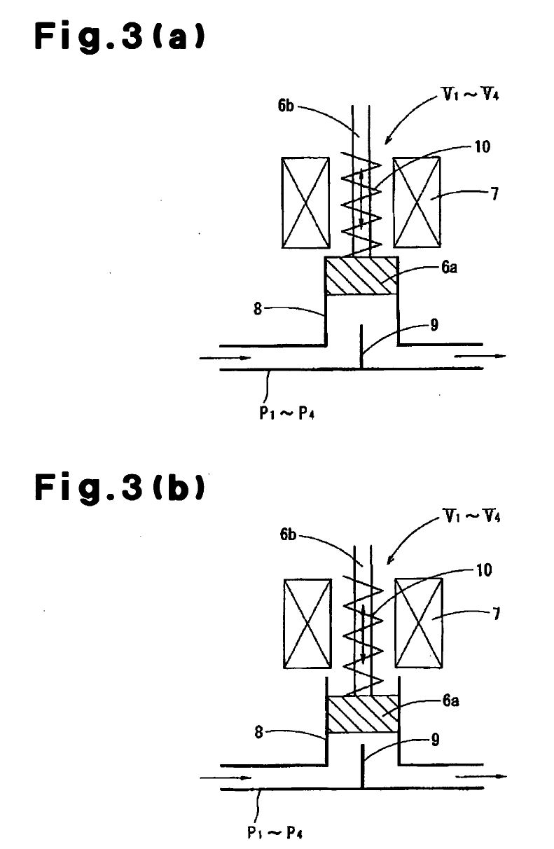

As shown in FIGS. 3(a) and 3(b), each of the refrigerant flow control valves V₁ to V₄ has an electromagnetic plunger 6 including a plunger head (a valve body) 6a and a plunger rod 6b, a solenoid coil 7 operating to raise the plunger rod 6b, and a valve closing spring 10 urging the plunger rod 6b downward. Each refrigerant flow control valve V₁ to V₄ is formed by an on-off type direct operated electromagnetic valve. The plunger head 6a faces a valve seat wall 9, which is located in a sleeve-like pilot recess 8 in each path P₁ to P₄.

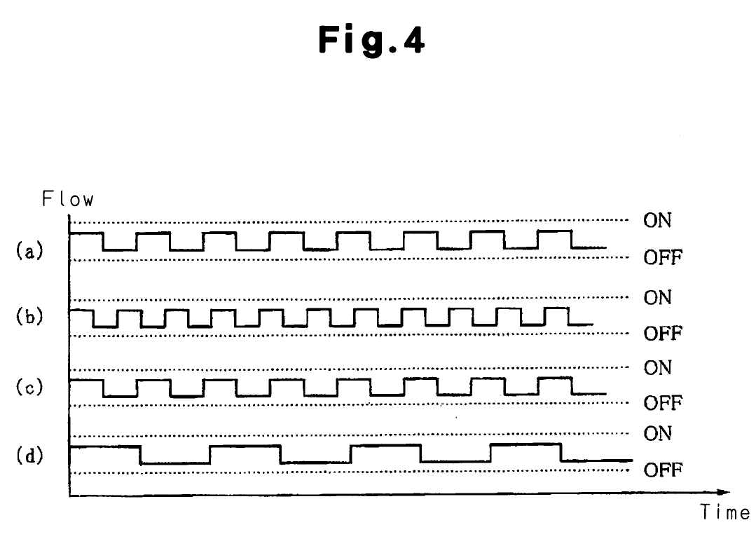

In this embodiment, each of the direct operated electromagnetic valves is switched between an ON state (an energized state shown in FIG. 3(a)) and an OFF state (a non-energized state shown in FIG. 3(b)) in correspondence with self-excited vibration control signals of different duty cycles illustrated in FIGS. 4(a) to 4(d), which do not cause the valve bodies to be fully closed. By opening and closing the direct operated electromagnetic valves in a vertical vibration state, the flow rate of the refrigerant in each path per unit time is adjusted appropriately in correspondence with the load state (the unevenness) of the paths P₁ to P₄.

In this manner, as in the first embodiment, instead of forming an electromagnetic flow control valve by an expensive and high-accuracy electric expansion valve, an inexpensive and simply configured direct operated electromagnetic valve is used as a refrigerant flow control valve. This reduces the size and the cost of the refrigerant flow divider. As a result, if used in an air conditioner having a reheat dehumidification heat exchanger, the refrigerant flow divider is optimal as a refrigerant flow divider that appropriately distributes refrigerant to a plurality of paths of a heat exchanger for a refrigerating device.

### Third Embodiment

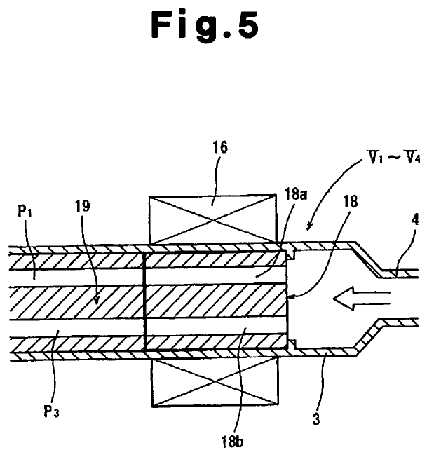

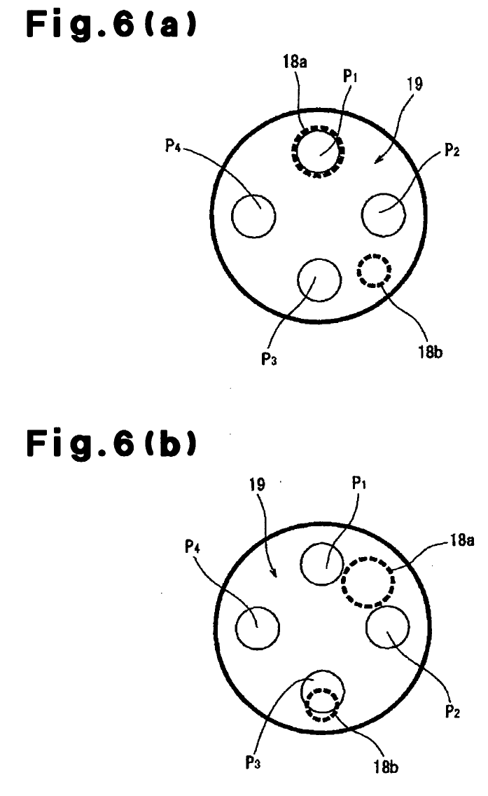

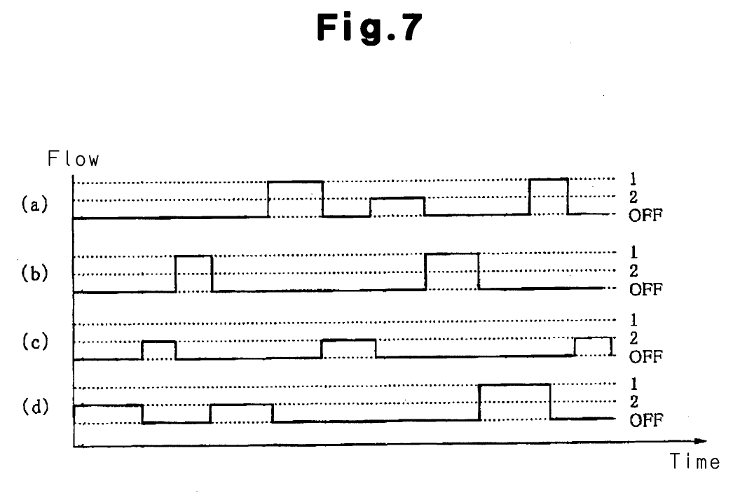

Also in a third embodiment, the refrigerant flow control valves V₁ to V₄ are used to adjust the flow rate of the refrigerant in each path P₁ to P₄ of the refrigerant flow divider 3 of the conventional air-conditioner heat exchanger 1, which is shown in FIG. 9 or 10. In this embodiment, the refrigerant flow control valves V₁ to V₄ are formed by a rotary type electromagnetic valve, as illustrated in FIGS. 5 and 6, and controlled in correspondence with rotary valve rotation control signals, which are represented in FIGS. 7(a) to 7(d).

As shown in FIG. 5, the rotary type electromagnetic valve includes a divider body corresponding to the paths P₁ to P₄. A fixed member 19 and a rotary member 18 are provided in the divider body and held in contact with each other. The fixed member 19 has a plurality of passage holes corresponding to the paths P₁ to P₄. The rotary member 18 has a first passage hole 18a and a second passage hole 18b. A solenoid coil 16 is arranged outside the rotary member 18 to rotate the rotary member 18 by electromagnetic force.

To rotate the rotary member 18, rotation control signals of different cycles and different on-voltage levels, which are shown in FIGS. 7(a) to 7(d), are provided to the solenoid coil 16. This changes the relationship between the positions of the passage holes of the fixed member 19 and the positions of the first and second passage holes 18a, 18b of the rotary member 18 (the overlapped surface areas between these passage holes), as illustrated in, for example, FIGS. 6(a) and 6(b). In this manner, the flow rate of the refrigerant flowing in each path P₁ to P₄ is adjusted, and unevenness of flow is prevented from occurring. The flow rate of the refrigerant flowing in the path P₁ to P₄ is great when held in the state of FIG. 6(a) and small when held in the state of FIG. 6(b).

Accordingly, as in the first and second embodiments, instead of forming an electromagnetic flow control valve by an expensive and high-accuracy electric expansion valve, a single inexpensive and simply configured rotary type electromagnetic valve is used as a refrigerant flow control valve. This further reduces the size and the cost of the refrigerant flow divider. As a result, if used in an air conditioner having a reheat dehumidification heat exchanger, the refrigerant flow divider is optimal as a refrigerant flow divider that appropriately distributes refrigerant to a plurality of paths of a heat exchanger for a refrigerating device.

### Fourth Embodiment

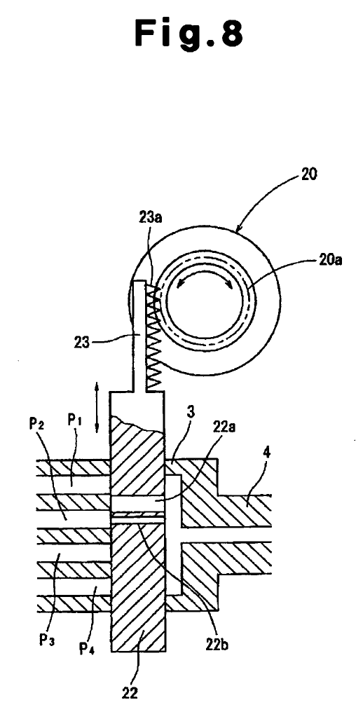

Also in a fourth embodiment, the refrigerant flow control valves V₁ to V₄ are used to adjust the flow rate of the refrigerant in each path P₁ to P₄ of the refrigerant flow divider 3 of the conventional air-conditioner heat exchanger 1, which is shown in FIG. 9 or 10. In this embodiment, the refrigerant flow control valves V₁ to V₄ are formed by a sliding type movable valve 22, as illustrated in FIG. 8. The movable valve 22 is slid using a stepping motor 20, which is subjected to pulse control, so as to adjust the flow rate of the refrigerant in each path P₁ to P₄ as needed. Unevenness of flow is thus prevented from occurring.

The movable valve 22 has a shaft portion 23 having a rack gear 23a, which is located near an upper end of the movable valve 22. A pinion gear 20a of the stepping motor 20 is engaged with the rack gear 23a of the shaft portion 23. The movable valve 22 is raised and lowered by a stroke amount that is set in correspondence with the rotating direction and the rotation number of the pinion gear 20a.

A large-diameter passage is provided in the vicinity of an inlet of a divider body of the refrigerant flow divider 3 into which the refrigerant is supplied. The multiple paths P₁ to P₄ are provided in the vicinity of the outlet of the divider body through which the refrigerant is sent to the exterior. The movable valve 22 is arranged between the large-diameter passage and the paths P₁ to P₄ to be vertically movable. A first passage hole 22a with a larger diameter and a second passage hole 22b with a smaller diameter are defined in the vicinity of the center of the movable valve 22. The first passage hole 22a and the second passage hole 22b are located relative to each other in accordance with a prescribed relationship. The relationship between the positions of the first and second passage holes 22a, 22b and the positions of the passage holes of the paths P₁ to P₄ (the overlapped surface areas between these passage holes are) is changed depending on the stroke amount of the movable valve 22.

Accordingly, as in the first to third embodiments, instead of forming an electromagnetic flow control valve by an expensive and high-accuracy electric expansion valve, a single inexpensive and simply configured sliding type electromagnetic valve is used as a refrigerant flow control valve. This further reduces the size and the cost of the refrigerant flow divider. As a result, if used in an air conditioner having a reheat dehumidification heat exchanger, the refrigerant flow divider is optimal as a refrigerant flow divider that appropriately distributes refrigerant to a plurality of paths of a heat exchanger for a refrigerating device.

1. A controller of a refrigerant flow divider of a heat exchanger for a refrigerating device, the controller supplying refrigerant to each one of a plurality of paths of the heat exchanger through the refrigerant flow divider having a plurality of paths,
the controller being characterized in that an electromagnetic on-off valve is provided in each of the paths of the refrigerant flow divider, the flow rate of the refrigerant in each path being adjusted relatively in correspondence with the difference in the number of times of the opening and closing per unit time among the electromagnetic on-off valves.

2. The controller according to claim 1, characterized in that the flow rate of the refrigerant in each path is adjusted relatively by opening and closing each of the electromagnetic on-off valves by a predetermined duty cycle.

3. The controller according to claim 1, characterized in that the flow rate of the refrigerant in each path is adjusted relatively by causing self-excited vibration of each of the electromagnetic on-off valves by a predetermined cycle.

4. The controller according to any one of claims 1, 2, and 3, characterized in that each electromagnetic on-off valve is a direct operated electromagnetic valve.

5. The controller according to claims 1 or 2, characterized in that the electromagnetic on-off valves are formed by a rotary type electromagnetic valve.

6. The controller according to claims 1 or 2 characterized in that the electromagnetic on-off valves are formed by a sliding type electromagnetic valve.
